(19) United States
(12) Patent Application Publication
(10) Pub. No.: US 2020/0071128 A1
(43) Pub. Date: Mar. 5, 2020

(54) ELEVATOR SYSTEM

(71) Applicant: Kone Corporation, Helsinki (FI)

(72) Inventors: Ari KATTAINEN, Helsinki (FI); Jari KANTOLA, Helsinki (FI)

(73) Assignee: Kone Corporation, Helsinki (FI)

(21) Appl. No.: 16/458,837

(22) Filed: Jul. 1, 2019

(30) Foreign Application Priority Data
Aug. 31, 2018 (EP) 18191950.7

(51) Int. Cl. B66B 5/04; B66B 5/00; B66B 5/16

(52) U.S. Cl. CPC B66B 5/04; B66B 5/0093; B66B 5/16; B66B 5/0031

(57) ABSTRACT

According to an aspect, there is provided an elevator system comprising an elevator car configured to move in an elevator shaft; a main safety controller comprising a main safety output and a secondary safety output, wherein the main safety output is configured to control machinery brakes of the elevator car; and a secondary safety circuit connected to the secondary safety output and arranged in the elevator car and comprising at least one safety contact configured to control stopping means arranged in the elevator car; wherein when the at least one safety contact is triggered the secondary safety circuit is configured to control the stopping means to cause stopping of the elevator car.

This application claims priority to European Patent Application No. EP-18191950.7 filed on Aug. 31, 2018, the entire contents of which are incorporated herein by reference.

### BACKGROUND

Safety is an important factor in elevator systems. These systems may comprise a number of safety devices providing signals for a controlling unit, for example, a safety circuit board. The controlling unit then determines whether operation of an elevator car is possible.

When performing maintenance operations, a serviceman may override the safety circuit intentionally or unintentionally. The safety circuit may also become short-circuited, for example, by dirt in shaft electronics or wear of a traveling cable, leaving safety measures in the shaft completely inoperable. This is a critical safety issue especially in elevators With elevator shafts having low/no headroom or pit, according to regulations there has to be a device limiting the elevator car travel, normally activated when the safety circuit is in the inspection mode. However, it may be possible that the device limiting the elevator car travel has also been short-circuited.

Thus, it would be beneficial to have a solution that would alleviate at least one of these drawbacks.

### SUMMARY

According to at least some of the aspects, a solution is provided that enables stopping an elevator car even if all electrically controlled stopping devices have become non-operational.

According to a first aspect of the invention, there is provided an elevator system comprising an elevator car configured to move in an elevator shaft; a main safety controller comprising a main safety output and a secondary safety output, wherein the main safety output is configured to control machinery brakes of the elevator car; and a secondary safety circuit connected to the secondary safety output and arranged in the elevator car and comprising at least one safety contact configured to control stopping means arranged in the elevator car. When the at least one safety contact is triggered the secondary safety circuit is configured to control the stopping means to cause stopping of the elevator car.

In an embodiment, the stopping means comprises a solenoid, an engagement mechanism and a safety gear, wherein in response to triggering the at least one contact, the solenoid is configured to cause the engagement mechanism to move to a position enabling contact with a triggering device in the elevator shaft, the triggering device in turn causing activation of the safety gear.

In an embodiment, the main safety controller comprises a first input connected to the solenoid, wherein the main safety controller is configured test the operation of the solenoid by switching off the secondary safety output and determining whether feedback information is received from the solenoid at the first input.

In an embodiment, the main safety controller is configured to test the operation of the solenoid at each stop of the elevator car.

In an embodiment, the main safety controller is configured to test the operation of the solenoid when testing the operation of the machinery brakes of the elevator car.

In an embodiment, alternatively on in addition, the at least one safety contact is associated with at least one balustrade contact.

In an embodiment, alternatively on in addition, the main safety controller comprises a second input connected to the at least one balustrade contact, wherein the main safety controller is configured to receive a signal at the second input when the at least one balustrade contact is triggered.

In an embodiment, alternatively on in addition, the at least one safety contact comprises an ascending car overspeed protection contact.

In an embodiment, alternatively on in addition, the at least one safety contact comprises a safety light curtain configured to be triggered when detecting an obstacle under the elevator car.

In an embodiment, alternatively on in addition, the at least one safety contact comprises at least one pressure sensor on the roof of the elevator car.

### BRIEF DESCRIPTION OF THE DRAWINGS

The accompanying drawings, which are included to provide a further understanding of the invention and constitute a part of this specification, illustrate embodiments of the invention and together with the description help to explain the principles of the invention. In the drawings:

FIG. 1A illustrates a block diagram of an elevator system according to an aspect.

FIG. 1B illustrates a block diagram of an elevator system according to another aspect.

FIG. 2 illustrates an elevator car in an elevator shaft according to an embodiment.

FIG. 3 illustrates an elevator car in an elevator shaft according to another embodiment.

### DETAILED DESCRIPTION

In the following a solution is provided in which a secondary safety circuit separate from a first safety circuit associated with machinery brakes of an elevator car is provided for securing a safety space when the roof of an elevator car or a shaft pit is occupied.

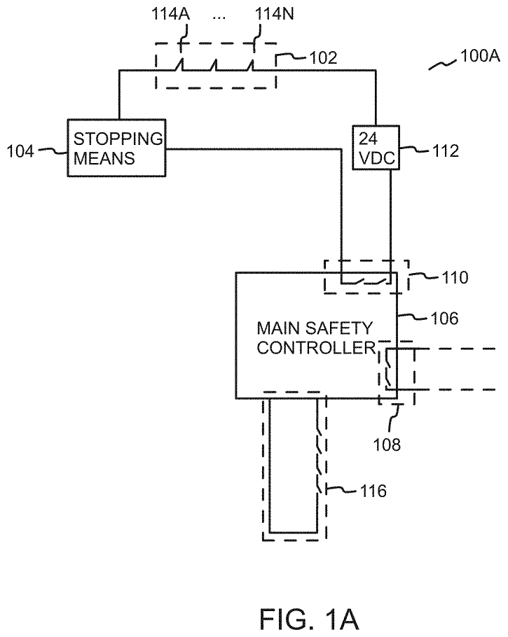

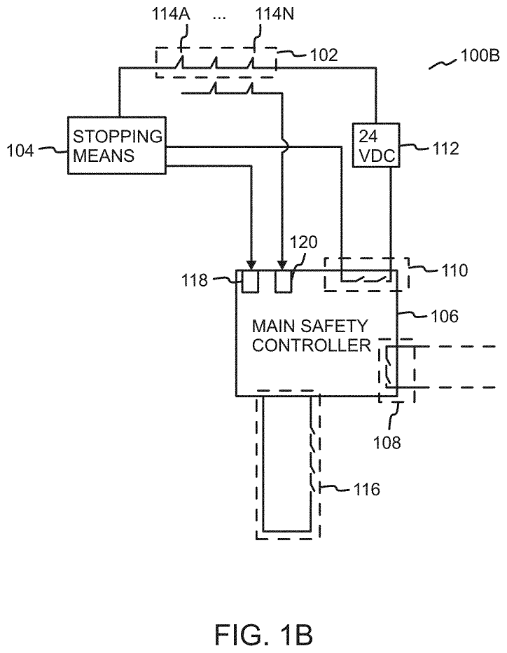

FIG. 1A illustrates a block diagram of an elevator system 100A according to an aspect. The elevator system 100A comprises a main safety controller 106 configured to control safety operations of the elevator system 100A comprising at least one elevator car. The main safety controller 106 is configured to monitor a status of a first safety circuit 116, and if there are no issues with the first safety circuit 116, the main safety controller 106 controls via a main safety output 108 power supply to the machinery and/or machinery brakes of the elevator. The safety circuit 116 may comprise a plurality of switches that monitor the operation of various elements, such as car and landing doors, car position and overspeed governor, in the elevator system.

In addition to the first safety circuit, the elevator system 100A comprises a secondary safety circuit 102. The secondary safety circuit 102 is connected to a secondary safety output 110 of the main safety controller 106 and arranged in the elevator car. A power source 112 may be provided to provide power to the secondary safety circuit 102. The secondary safety circuit 102 comprises at least one safety contact 114A . . . 114N configured to control stopping means 104 arranged in the elevator car. In an example, regardless of the status of the main safety circuit 106 or the machinery brakes, the secondary safety circuit 102 is able to cause stopping of the elevator car. When the at least one safety contact 114A . . . 114N is triggered, the secondary safety circuit 102 is configured to control the stopping means 104 to cause stopping of the elevator car.

The at least one safety contact 114A . . . 114N may comprise different types of elements. The at least one safety contact 114A . . . 114N may be related to one or more balustrades arranged on the roof of the elevator car. When the balustrade is moved from its resting position either upwards (as in setting it up) or downwards (as when a person is standing on a folded-down balustrade), this is detected, for example, by at least one switch arranged in connection with the balustrade. As the safety contact associated with the balustrade is a normally closed (NC) contact, the safety contact opens when the balustrade is deviated from its resting position and, thus, causes a state change in the secondary safety circuit 102.

Another example of possible safety contacts 114A . . . 114N comprises an ascending car overspeed protection (ACOP) contact associated with a specific speed limit. For example, the safety contact may be a 115% normally closed safety contact. This means that when a specific speed limit of the elevator car is exceeded by 15%, the normally closed safety contact opens and causes a state change in the secondary safety circuit 102.

Another example of possible safety contacts 114A . . . 114N comprises a safety light curtain configured to be triggered when detecting an obstacle under the elevator car. The safety light curtain may be used to detect obstacles below the elevator car in the elevator shaft.

Another example of possible safety contacts 114A . . . 114N comprises at least one pressure sensor on the roof of the elevator car. For example, a pressure mat may be arranged on the roof of the elevator car to detect any person present on the roof.

In an embodiment, the stopping means 104 comprises a solenoid, an engagement mechanism and a safety gear. The secondary safety circuit 102 is connected to the solenoid. Normally, when all the safety contacts 114A . . . 114N of the secondary safety circuit 102 are in their normal state, i.e. in the normally closed state, electricity flows to the solenoid and its plunger is in a retracted position. When the state of one of the safety contacts 114A . . . 114N changes, the electricity flow to the solenoid is interrupted. This causes the plunger to protrude and make contact with the engagement mechanism. The engagement mechanism in turn moves to a position that enables a contact with a triggering device located in the elevator shaft. The triggering device causes activation of the safety gear of the elevator car. The triggering device may be located close to the upper end of the elevator shaft. Thus the stopping means 104 together with the secondary safety circuit 102 and the triggering device enable creating a safety space in the elevator shaft.

FIG. 1B illustrates a block diagram of an elevator system according to another aspect. The example illustrated in FIG. 1B is similar than was already illustrated in FIG. 1A, and already discussed elements are not discussed again, and reference is made to the description of FIG. 1A.

As illustrated in FIG. 1B, the elevator system 100B may additionally comprise a feedback loop from the stopping means 104 received at a first input 118 at the main safety controller 106. If the stopping means 104 comprise the earlier discussed solenoid, the main safety controller 106 may be configured to switch off the secondary safety output 110. This causes interruption of the electrical power supply to the solenoid. If the solenoid works properly, the end result should be that the plunger of the solenoid protrudes. If the solenoid is faulty, it may be that nothing happens. In any case, information about the state change of the solenoid is received at the first input 118 of the main safety controller 106. Thus, if an expected signal in response to switching off the secondary safety output 110 is not received from the solenoid, the solenoid is determined to be faulty.

When the main safety controller 106 is configured to switch off the secondary safety output 110, the main safety controller 106 may stop controlling a normally open (NO) switch or switches of the secondary safety output 110. This in turn breaks the secondary safety circuit 102, and the electrical power supply to the solenoid is interrupted, as already discussed above.

The testing of the solenoid can be performed, for example, at each stop of the elevator car. This ensures continuous monitoring of the solenoid and if the solenoid if faulty, this can be detected quickly. In another example, the testing of the solenoid is performed simultaneously when testing the operation of the machinery brakes of the elevator car. The machinery brake testing and thus also the solenoid testing, may be performed, for example, once in every 11 hours. It is evident that the testing period of the solenoid may also be any other time period, for example, one day.

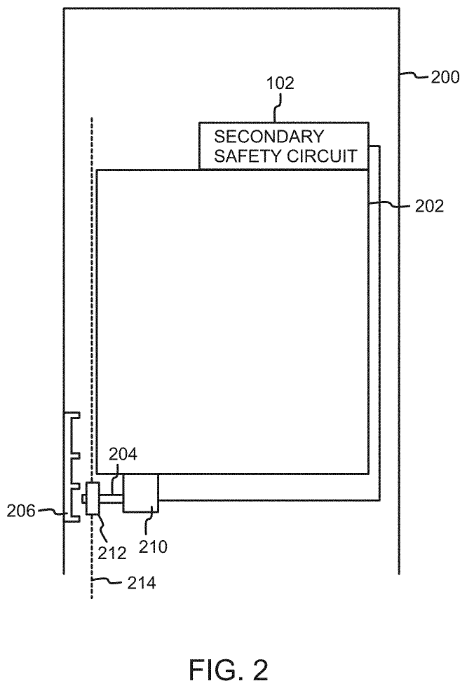

FIG. 2 illustrates an elevator car 202 in an elevator shaft 200 according to an embodiment.

The secondary safety circuit 102 has been arranged in the elevator car 202. The operation of the secondary safety circuit 102 has been discussed in more detail in relation to FIGS. 1A and 1B, and therefore, this discussion is not repeated here, and reference is made to the description of FIGS. 1A and 1B. The solenoid 210 is connected to the secondary safety circuit 102.

FIG. 2 discloses a simplified illustration of how the solenoid 210 is behaving when the electricity flow to the solenoid 210 is interrupted in response to triggering at least one safety contact of the secondary safety circuit 102. This causes an engagement mechanism 204, for example, a plunger to protrude. The engagement mechanism 204, i.e. the plunger, then in turn moves to a position that will contact the triggering device 206 located in the elevator shaft 200 when the elevator car 202 moves upwards in the elevator shaft 200. When the engagement mechanism 204 contacts the triggering device 206 and when the elevator car 202 continues to move upwards in the elevator shaft, the triggering device 206 prevents the engagement mechanism 204 to move freely with the elevator car 202. This in turn prevents a speed limiting rope 214 to move freely with the elevator car 202, causing a safety gear 212 of the elevator car 202 to tighten to a guide rail in the elevator shaft, eventually stopping the elevator car 202. Thus, by using the secondary safety circuit and the solenoid and depending on the position of the triggering device 206 in the elevator, a safety space having a desired size can be created in the elevator shaft 200. Although FIG. 2 illustrates one exemplary form for the triggering device 206, it is evident that the triggering device 206 may take any other appropriate form that is able to cooperate with the plunger 208.

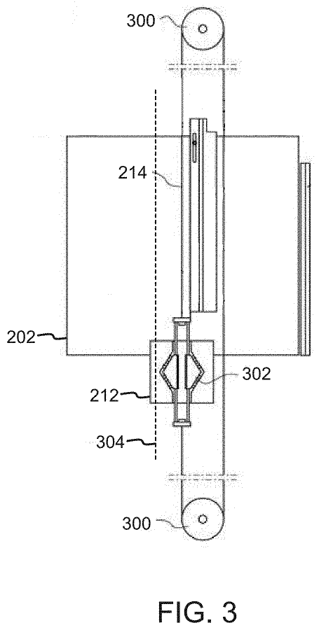

FIG. 3 illustrates an elevator car 202 in an elevator shaft according to another embodiment. FIG. 3 discloses a different view of the arrangement illustrated in FIG. 2. The elevator car 202 is configured to move in the elevator shaft. It is evident that FIG. 3 may not necessarily disclose all elements present in the elevator shaft.

When the elevator car moves in the elevator shaft, the speed limiting rope 214 moves together with the elevator car 202. Diverting pulleys 300 may be used at each end of the elevator shaft in connection with the speed limiting rope 214. When the electricity flow to the solenoid 210 is interrupted, this causes an engagement mechanism 204, for example, a plunger to protrude. The engagement mechanism 204, i.e. the plunger, then in turn moves to a position that will contact the triggering device 206 located in the elevator shaft 200 when the elevator car 202 moves upwards in the elevator shaft 200. When the engagement mechanism 204 contacts the triggering device 206 and when the elevator car 202 continues to move upwards in the elevator shaft, the triggering device 206 prevents the engagement mechanism 204 to move freely with the elevator car 202. This in turn prevents the speed limiting rope 214 to move freely with the elevator car 202, causing a safety gear 302 of the elevator car 202 to tighten to a guide rail 304 in the elevator shaft, eventually stopping the elevator car 202.

One or more of the above embodiments may provide at least one of the following benefits. As the disclosed solution provides a mechanical solution for stopping the elevator car, the solution works even if the elevator car approaches an end of the elevator shaft during a power failure. Further, if the first safety circuit is short-circuited, this does not have any effect on the operation of the secondary safety circuit. Further, even if it happens that the secondary safety circuit is short-circuited, this will be realized when testing the solenoid. Further, it is not possible to perform the short-circuiting of the secondary safety circuit from a maintenance access panel as the wiring associated with the solenoid and the at least one safety contact is in the elevator car.

Example embodiments may be implemented in software, hardware, application logic or a combination of software, hardware and application logic. The example embodiments can store information relating to various methods described herein. This information can be stored in one or more memories, such as a hard disk, optical disk, magneto-optical disk, RAM, and the like. One or more databases can store the information used to implement the example embodiments. The databases can be organized using data structures (e.g., records, tables, arrays, fields, graphs, trees, lists, and the like) included in one or more memories or storage devices listed herein.

All or a portion of the example embodiments can be conveniently implemented using one or more general purpose processors, microprocessors, digital signal processors, micro-controllers, and the like, programmed according to the teachings of the example embodiments, as will be appreciated by those skilled in the computer and/or software art(s). Stored on any one or on a combination of computer readable media, the examples can include software for controlling the components of the example embodiments, for driving the components of the example embodiments, for enabling the components of the example embodiments to interact with a human user, and the like. Such computer readable media further can include a computer program for performing all or a portion (if processing is distributed) of the processing performed in implementing the example embodiments. In the context of this document, a “computer-readable medium” may be any media or means that can contain, store, communicate, propagate or transport the instructions for use by or in connection with an instruction execution system, apparatus, or device, such as a computer. A computer-readable medium may include a computer-readable storage medium that may be any media or means that can contain or store the instructions for use by or in connection with an instruction execution system, apparatus, or device, such as a computer. A computer readable medium can include any suitable medium that participates in providing instructions to a processor for execution. Such a medium can take many forms, including but not limited to, non-volatile media, volatile media, transmission media, and the like.

The applicant hereby discloses in isolation each individual feature described herein and any combination of two or more such features, to the extent that such features or combinations are capable of being carried out based on the present specification as a whole, in the light of the common general knowledge of a person skilled in the art, irrespective of whether such features or combinations of features solve any problems disclosed herein, and without limitation to the scope of the claims. The applicant indicates that the disclosed aspects/embodiments may consist of any such individual feature or combination of features. In view of the foregoing description it will be evident to a person skilled in the art that various modifications may be made within the scope of the disclosure.

1. An elevator system comprising:
an elevator car configured to move in an elevator shaft;
a first safety circuit;
a main safety controller comprising a main safety output and a secondary safety output, wherein the main safety output is configured to control machinery brakes of the elevator car based on the first safety circuit; and
a secondary safety circuit connected to the secondary safety output and arranged in the elevator car and comprising at least one safety contact configured to control stopping means arranged in the elevator car;
wherein when the at least one safety contact is triggered the secondary safety circuit is configured to control the stopping means to cause stopping of the elevator car.

2. The elevator system of claim 1, wherein the stopping means comprises a solenoid, an engagement mechanism and a safety gear, wherein in response to triggering the at least one contact, the solenoid is configured to cause the engagement mechanism to move to a position enabling contact with a triggering device in the elevator shaft, the triggering device in turn causing activation of the safety gear.

3. The elevator system of claim 2, wherein the main safety controller comprises a first input connected to the solenoid, wherein the main safety controller is configured test the operation of the solenoid by switching off the secondary safety output and determining whether feedback information is received from the solenoid at the first input.

4. The elevator system of claim 3, wherein the main safety controller is configured to test the operation of the solenoid at each stop of the elevator car.

5. The elevator system of claim 3, wherein the main safety controller is configured to test the operation of the solenoid when testing the operation of the machinery brakes of the elevator car.

6. The elevator system of claim 1, wherein the at least one safety contact is associated with at least one balustrade contact.

7. The elevator system of claim 6, wherein main safety controller comprises a second input connected to the least one balustrade contact, wherein the main safety controller is configured to receive a signal at the second input when the at least one balustrade contact is triggered.

8. The elevator system of claim 1, wherein the at least one safety contact comprises an ascending car overspeed protection contact.

9. The elevator system of claim 1, wherein the at least one safety contact comprises a safety light curtain configured to be triggered when detecting an obstacle under the elevator car.

10. The elevator system of claim 1, wherein the at least one safety contact comprises at least one pressure sensor on the roof of the elevator car.
